(19) United States
(12) Patent Application Publication
(10) Pub. No.: US 2005/0195886 A1
(43) Pub. Date: Sep. 8, 2005

(54) CPICH processing for SINR estimation in W-CDMA system

(75) Inventors: Marko Lampinen, Oulu (FI); Tuomas Saukkonen, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/792,018

(22) Filed: Mar. 2, 2004

(51) Int. Cl. H04B 1/707

(52) U.S. Cl. 375/144; 375/148

(57) ABSTRACT

A method and system for estimating the signal-to-interference plus noise ratio (SINR) of the common pilot channel (CPICH) in a W-CDMA receiver. The SINR estimation is carried out after chip level filtering and then the despreading of the CPICH channel. In the case of space-time transmit diversity, a virtual space-time decoding is used on the CPICH channel in order to mimic data channel data channel space-time transformation. The estimated SINR can be used for a User Equipment to report its channel quality indicator to a Node B.

### FIELD OF THE INVENTION

The present invention generally relates to HS-DSCH (High-Speed Downlink Shared Channel) related-procedures and, more particularly, to the channel quality indicator (CQI) derived and reported by an UE (User Equipment) in W-CDMA.

### BACKGROUND OF THE INVENTION

In 3GPP TS 25.214 V5.4.0 (2003-03) “Physical layer procedure (FDD)” (Release 5) (hereafter referred to as TS 25.214), the UE needs to report the channel quality indicator (CQI) for HS-DSCH rate adaptation and user scheduling. In particular, some of the physical layer parameters signaled to the UE and the Node B from higher layers are as follows:
CQI feedback cycle k;
Repetition factor of CQI: N_cqi_transmit; and
Measurement power offset Γ.
   As part of the UE procedure for reporting CQI, the UE derives the CQI value and transmits the CQI value only when k>0 repeatedly over the next (N_cqi_transmit−1) consecutive HS-DPCCH (Dedicated Physical Control Channel) sub-frames in the slots allocated to the CQI. For the purpose of CQI reporting, the UE assumes a total received power for HS-PDSCH (Physical Downlink Shared Channel) to be the sum of the power offset Γ, the power of the received CPICH (Common Pilot Channel), and a reference power adjustment term. The CQI can be based on the SINR (Signal-to-Interference plus Noise Ratio) of the CPICH, for example.

It is desirable and advantageous to provide a simple method for estimating the CPICH SNIR with transmit and/or receive diversity processing and different receivers such as rake or equalizers.

### SUMMARY OF THE INVENTION

The present invention provides a CPICH (Common Pilot Channel) processing method for estimating the SINR (Signal-to-Interference plus Noise Ratio) of the CPICH, in a SISO (single-input single-output) case and in a STTD (space-time transmit diversity) case. In the STTD case, the power of the received CPICH is the combined power from each of the transmit antennas. Multiple receive antennae processing can be applied with the CPICH processing.

Thus, the first aspect of the present invention provides a method for estimating interference in Common Pilot Channel (CPICH) in a W-CDMA receiver comprising an equalization stage for chip level filtering of received chips. The method comprises:
despreading the CPICH channel after said chip level filtering; and
estimating the signal to interference ratio at least partially from despread CPICH symbols.

According to the present invention, the W-CDMA receiver is for use in a communications system having a transmitter with single antenna transmission. The receiver can also be used in a communications system having a transmitter with space-time transmit diversity transmission, wherein a virtual space-time decoding is used on the CPICH channel in order to mimic data channel space-time transformation, and wherein the received chips are over-sampled at chip-level.

The second aspect of the present invention provides a receiver for use in a communications system. The receiver comprises:
an equalization stage for chip level filtering received chips;
a despreading module for despreading a common pilot channel after said chip level filtering; and
an estimation module for estimating signal-to-interference ratio at least partially from despread CPICH symbols.

According to the present invention, the estimated signal-to-interference ratio is for use by a user equipment in the communications system to report its channel quality indicator (CQI).

According to the present invention, the communications system comprises a transmitter with single antenna transmission, or a transmitter with space-time transmit diversity transmission.

The third aspect of the present invention provides a W-CDMA communications system, which comprises:
a receiver; and
a transmitter for transmitting a signal stream to the receiver, the signal stream containing a chip stream in a common pilot channel (CPICH), wherein the receiver has at least one antenna to receive one or more chips in the chip stream; the receiver further comprising:
an equalization stage for chip level filtering the received chips;
a despreading module for despreading the common pilot channel after said chip level filtering; and
an estimation module for estimating signal-to-interference ratio at least partially from despread CPICH symbols.

According to the present invention, the transmitter has a single antenna for transmitting the signal stream.

Alternatively, the transmitter has two or more antennas for transmitting the signal stream in order to achieve space-time transmit diversity, and a virtual space-time decoding in the receiver is used on the CPICH in order to mimic data channel space-time transformation.

The fourth aspect of the present invention provides a communications device in a communications system, comprising:
an antenna; and
a receiver, operatively connected to the antenna for receiving communication signals, wherein the communication signals includes a transmitted signal indicative of one or more chips in a chip stream in a common pilot channel (CPICH); and wherein the received signals include received chips, the receiver comprising:
an equalization stage for chip level filtering received chips;
a despreading module for despreading a common pilot channel (CPICH) after said chip level filtering; and
an estimation module for estimating signal-to-interference ratio at least partially from despread CPICH symbols.

According to the present invention, the estimated signal-to-interference ratio is used for reporting a channel quality indicator (CQI) to another component in the communication system.

According to the present invention, the communications signals are transmitted with a single antenna at a transmit side, or with space-time transmit diversity transmission.

The communications device can be a mobile phone or terminal or the like.

The present invention will become apparent upon reading the description taken in conjunction with FIGS. 1 to 6.

### BRIEF DESCRIPTION OF THE DRAWINGS

FIG. 1 is a block diagram showing the system model for SISO system for SISO SINR estimation.

FIG. 2 is a block diagram showing the system model for STTD system for STTD SINR estimation.

FIG. 3 is a schematic representation showing the response of the channel and equalizer for STTD.

FIG. 4 is a matrix showing a channel coefficient matrix model for impulse response of the channel.

FIG. 5 is a matrix showing a channel coefficient sub-matrix for the impulse response.

FIG. 6 is a schematic representation of a communications network that can be used for W-CDMA communications, according to the present invention.

### DETAILED DESCRIPTION OF THE INVENTION

According to 3GPP TS 25.214 V5.4.0 (2003-03) “Physical layer procedure (FDD)” (Release 5), the UE needs to report the channel quality indicator (CQI) for HS-DSCH rate adaptation and user scheduling. For the purpose of CQI reporting, the UE relies partly on the power of the received CPICH (Common Pilot Channel). The CQI can be based on the SINR (Signal-to-Interference plus Noise Ratio) of the CPICH, for example. The present invention provides a CPICH processing method for estimating SINR in a SISO (single-input single-output) case, SIMO (single-input multiple-output) case and in a STTD (space-time transmit diversity) case. Multiple receive antennas may be used as well as different receiver algorithms such as equalizers.

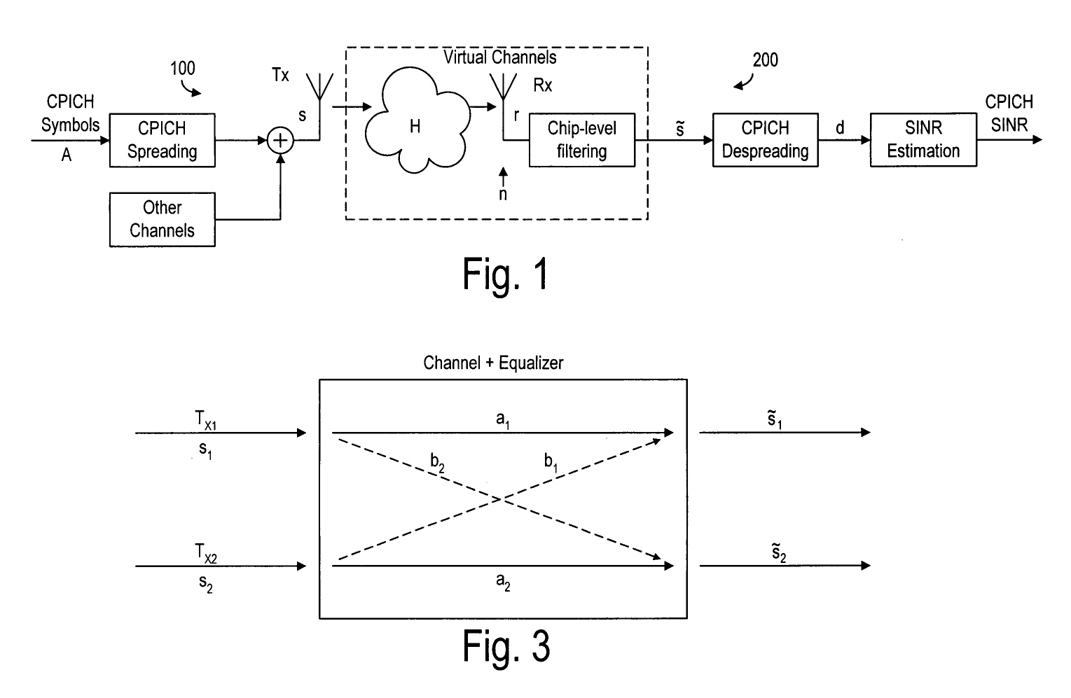

The system model for a SISO or SIMO system for the purpose of SINR estimation is shown in FIG. 1. The CPICH symbol pattern is [A, A, . . . , A] for SISO. For STTD the transmitted CPICH symbol pair as transmitted from two antennas, or transmitted in the time reverse manner is given by

$${↓}_{Tx antenna} {[ \begin{matrix}A & A \\ A & - A\end{matrix} ]}_{\to time} \qquad ( 1 )$$

where A=1+j.

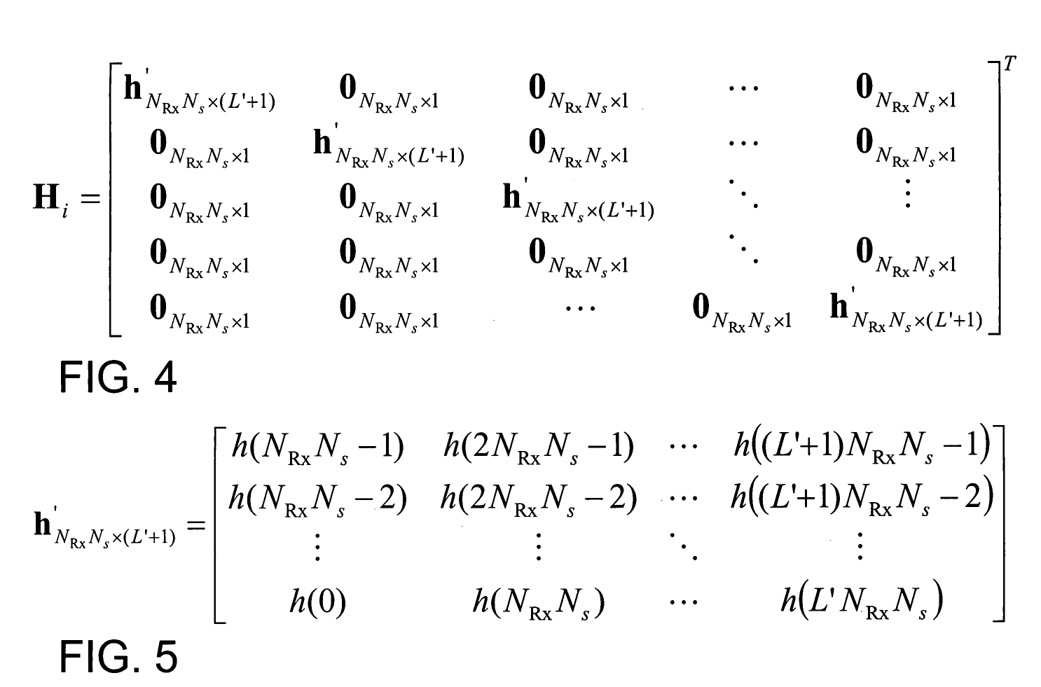

As shown in FIG. 1, after the CPICH Symbols are spread by a CPICH model, they are transmitted from the transmit side 100 by the antenna Tx as a part of the chip streams s. The received chip r at the receive side 200 is given by:
r=H^{T}s+n (2)
where H is the impulse response of the channel, and n is a noise term. A model of the impulse response is shown in a channel coefficient matrix in FIG. 4. The multiplication of s with the matrix H models a convolution with the impulse response of the channel. In the matrix H, the coefficient h′ is given by a sub-matrix as shown in FIG. 5. In FIGS. 4 and 5, N_{RX} and N_{S} are, respectively, the number of Rx-antennas and the number of samples for chip; L is the length of the impulse response and L′=L/N_{S}.

It can be seen from Eq. 2 that a linear chip equalizer, for example, can be used to estimate chip \tilde{s}. Let us assume that only chip-level processing is carried out. This has the advantage of the equalizer noise gain being optimized independently. Let a be the noise gain minimizing column of A where
A=(HH^{H}+R_{ZZ})⁻¹ (3)
which is a modified covariance matrix, and
w^{T}=(H^{H}a)^{T} (4)
Accordingly, we can obtain the chip estimate from Eq. 2 as follows:
\tilde{s}=w^{T}r (5)
Thus, filter weights w can be obtained by using, for example, the MMSE (minimum mean-square-error) criteria and a linear chip equalizer or some other well known algorithm (see Krauss et al., “Simple MMSE Equalizers for CDMA Downlink to Restore Chip Sequence: Comparison to Zero-Forcing and Rake”, Proceedings of 2000 IEEE International Conference on Acoustics, Speech and Signal Processing, Vol. 5, 2000, pp. 2865-2868). However, adaptive algorithms may also be used. It should be further noted that the algorithm does not need to be linear.

From chip estimate \tilde{s}, the CPICH symbols d can be extracted by despreading the signal by the CPICH despreading block, as shown in FIG. 1. As shown in FIG. 1, the combination of the channel and the receiver chip-level filtering at the equalization stage can be seen as a virtual channel. SINR estimation, such as conventional symbol level SINR estimation algorithm, is known in the art. Thus, SINR estimation is not a part of the present invention. However, SINR contains at least a term that is related to the despread CPICH symbols.

In the STTD case, the power of the received CPICH is the combined power from each of the transmit antennas. The received chips (or samples) at the receive side 200′ are given by:

$$r = {H}_{1}^{T} {s}_{1} + {H}_{2}^{T} {s}_{2} + n = {[ \begin{matrix}{H}_{1} \\ {H}_{2}\end{matrix} ]}^{T} [ \begin{matrix}{s}_{1} \\ {s}_{2}\end{matrix} ] + n \qquad ( 6 )$$

where s₁ and s₂ are the transmitted chip streams from Tx-antennas 1 and 2. The chip streams are obtained through symbol level STTD encoding of data according to the physical layer specifications. It can be seen from Eq. 6 that the chip pair (\tilde{s}₁ and \tilde{s}₂) can be estimated by using linear filters w₁ and w₂. The coefficients can be solved jointly or independently. By example, let's assume that a₁ is the noise gain minimizing column of A₁ and a₂ respectively for A₂ where

$$[ \begin{matrix}{A}_{1} & M & {A}_{2}\end{matrix} ] = {( [ \begin{matrix}{H}_{1} {H}_{1}^{H} & {H}_{1} {H}_{2}^{H} \\ {H}_{2} {H}_{1}^{H} & {H}_{2} {H}_{2}^{H}\end{matrix} ] + {R}_{zz} )}^{- 1} \qquad ( 7 )$$

Accordingly, we have

$$[ \begin{matrix}{\tilde{s}}_{1} \\ {\tilde{s}}_{2}\end{matrix} ] = [ \begin{matrix}{( [ \begin{matrix}{H}_{1}^{H} & {H}_{2}^{H}\end{matrix} ] {a}_{1} )}^{T} r \\ {( [ \begin{matrix}{H}_{1}^{H} & {H}_{2}^{H}\end{matrix} ] {a}_{2} )}^{T} r\end{matrix} ] = [ \begin{matrix}{w}_{1}^{T} r \\ {w}_{2}^{T} r\end{matrix} ] \qquad ( 8 )$$

It should be noted that the chip pair might not be time aligned.

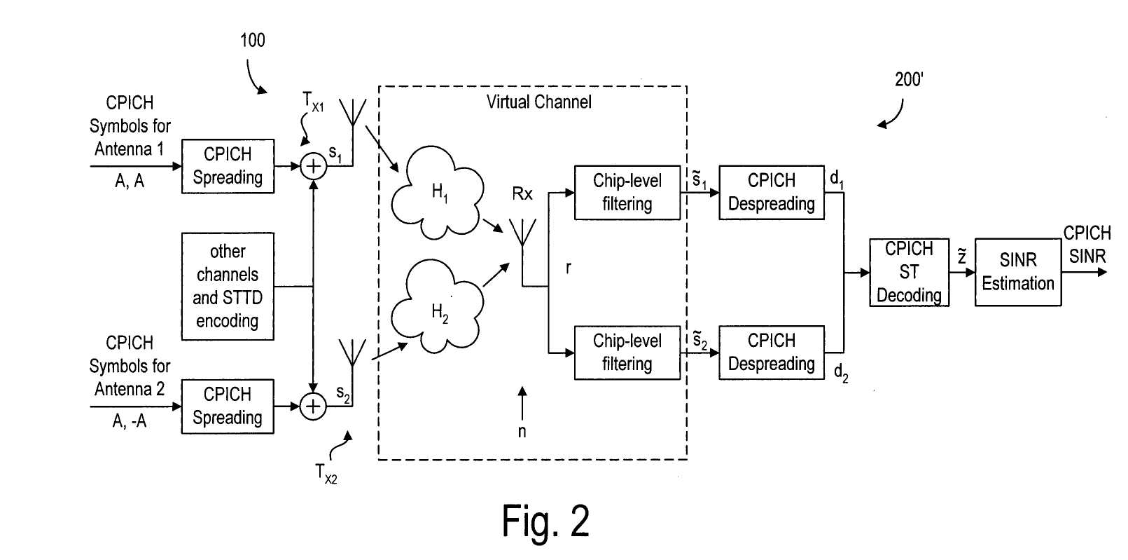

The combined system of the MIMO channel model and the receiver filters is shown in FIGS. 2 and 3. In FIG. 3, the coefficients a₁ and a₂ are real numbers and b₁, b₂ are complex numbers. The coefficients a₁, a₂ and b₁, b₂ can be calculated by convolving the equalizer coefficients with the channel profile. As mentioned above, the Rx antennas are handled as over-sampling. The despreading does not affect the weight because they can be assumed constant over a symbol period.

If the multi path channel, and the receiver filter pair can be seen as a virtual 2×2 channel as depicted in FIG. 3, then the received symbol pair is

$$\begin{matrix}R = {[ \begin{matrix}{a}_{1} & {b}_{2} \\ {b}_{1} & {a}_{2}\end{matrix} ]}^{T} [ \begin{matrix}A & A \\ A & - A\end{matrix} ] + n \\ = {[ \begin{matrix}{a}_{1} A & {b}_{2} A \\ {b}_{1} A & {a}_{2} A\end{matrix} ]}^{T} [ \begin{matrix}1 & 1 \\ 1 & - 1\end{matrix} ] + n\end{matrix} \qquad ( 9 )$$

If A is assumed to be part of the virtual coefficient and the imaginary part of the STTD encoded complex symbol is zero, the transmitted symbol is simply 1. Eq. 9 is equivalent to

$$R = {[ \begin{matrix}{a}_{1} A & {b}_{2} A \\ {b}_{1} A & {a}_{2} A\end{matrix} ]}^{T} [ \begin{matrix}{s}_{1} & {s}_{2} \\ {s}_{2}^{*} & - {s}_{1}^{*}\end{matrix} ] + n \qquad ( 10 )$$

with s₁=s₂=1.

It can be seen from Eq. 10 that the space-time decoding of CPICH provides the same SINR characteristics as those appearing on the associated physical channel. Finally, any symbol level SISO SINR estimation method can be used by assuming symbol pattern [1, 1, . . . , 1], and any conventional algorithm can be used to generate the CQI report. It should be also noted that the equalizer algorithm can be different from what is described above.

With the CPICH signal, the despread signal is

$$\begin{matrix}{D}^{pilot} = [ \begin{matrix}{d}_{1}^{pilot} \\ {d}_{2}^{pilot}\end{matrix} ] \\ = {[ \begin{matrix}{d}_{0 , 0}^{pilot} & {d}_{0 , 1}^{pilot} \\ {d}_{1 , 0}^{pilot} & {d}_{1 , 1}^{pilot}\end{matrix} ]}_{\to time} \\ = {[ \begin{matrix}{a}_{1} & {b}_{2} \\ {b}_{1} & {a}_{2}\end{matrix} ]}^{T} [ \begin{matrix}A & A \\ A & - A\end{matrix} ] + {n}^{′} \\ = {[ \begin{matrix}{a}_{1} A & {b}_{2} A \\ {b}_{1} A & {a}_{2} A\end{matrix} ]}^{T} [ \begin{matrix}1 & 1 \\ 1 & - 1\end{matrix} ] + {n}^{′}\end{matrix} \qquad ( 11 )$$

and equivalently,

$$\begin{matrix}{D}^{pilot} = {[ \begin{matrix}{d}_{0 , 0}^{pilot} & {d}_{0 , 1}^{pilot} \\ {d}_{1 , 0}^{pilot} & {d}_{1 , 1}^{pilot}\end{matrix} ]}_{\to time} \\ = {[ \begin{matrix}{a}_{1} A & {b}_{2} A \\ {b}_{1} A & {a}_{2} A\end{matrix} ]}^{T} [ \begin{matrix}{z}_{1} & {z}_{2} \\ {z}_{2}^{*} & - {z}_{1}^{*}\end{matrix} ] + {n}^{′}\end{matrix} \qquad ( 12 )$$

where z₁ and z₂=1. With left multiplication by A*, we have

$$\begin{matrix}{{D}^{pilot}}^{′} = {[ \begin{matrix}{{d}_{0 , 0}^{pilot}}^{′} & {{d}_{0 , 1}^{pilot}}^{′} \\ {{d}_{1 , 0}^{pilot}}^{′} & {{d}_{1 , 1}^{pilot}}^{′}\end{matrix} ]}_{\to time} \\ = {{\vert A \vert}^{2} [ \begin{matrix}{a}_{1} & {b}_{2} \\ {b}_{1} & {a}_{2}\end{matrix} ]}^{T} [ \begin{matrix}{z}_{1} & {z}_{2} \\ {z}_{2}^{*} & - {z}_{1}^{*}\end{matrix} ] + {n}^{″}\end{matrix} \qquad ( 13 )$$

With the data channel signal, the received STTD encoded symbols after despreading of the data channel are:

$$\begin{matrix}{D}^{data} = {[ \begin{matrix}{d}_{0 , 0}^{data} & {d}_{0 , 1}^{data} \\ {d}_{1 , 0}^{data} & {d}_{1 , 1}^{data}\end{matrix} ]}_{\to time} \\ = {[ \begin{matrix}{a}_{1} & {b}_{2} \\ {b}_{1} & {a}_{2}\end{matrix} ]}^{T} [ \begin{matrix}{x}_{0} & {x}_{1} \\ - {x}_{1}^{*} & {x}_{0}^{*}\end{matrix} ] + {n}^{′}\end{matrix} \qquad ( 14 )$$

In Eq. 14, [x₀, x₁] is the transmitted data symbol pair, and the residual inter-symbol interference is neglected.

Furthermore, if b₁=b₂*, the STTD combined signal for the data channel is

$$[ \begin{matrix}{\tilde{x}}_{1} \\ {\tilde{x}}_{2}\end{matrix} ] = [ \begin{matrix}{d}_{0 , 0}^{data} + {( {d}_{1 , 1}^{data} )}^{*} \\ {d}_{0 , 1}^{data} - {( {d}_{1 , 0}^{data} )}^{*}\end{matrix} ] \qquad ( 15 )$$

and the STTD combined signal for the CPICH or the time reverse is

$$[ \begin{matrix}{\tilde{z}}_{1} \\ {\tilde{z}}_{2}\end{matrix} ] = [ \begin{matrix}{d}_{0 , 0}^{{pilot}^{′}} - {( {d}_{1 , 1}^{{pilot}^{′}} )}^{*} \\ {d}_{0 , 1}^{{pilot}^{′}} + {( {d}_{1 , 0}^{{pilot}^{′}} )}^{*}\end{matrix} ] \qquad ( 16 )$$

It can be seen from Eq. 15 and Eq. 16, the diversity order of the decoded symbols is the same. The space-time decoded CPICH provides the same SINR characteristics as the data channel. Thus, a virtual space-time decoding can be used on the CPICH channel in order to mimic data channel space-time transformation.

In sum, the present invention provides a CPICH processing method for estimating SINR where channel and receiver filter are combined as a virtual channel. In particular, CPICH channel is despread after chip-level equalization, and SINR estimation is then performed using any conventional method. With this approach, the SINR is similar to the SINR of the associated channel. The disadvantage of this approach is the additional delay caused by the equalization. However, this delay can be considered as a small addition to the relatively large delay caused by the CQI reporting.

If STTD is used as a transmission method, a virtual space-time decoding is used for the CPICH channel in order to estimate the CPICH SINR.

It should be noted that the present invention has been disclosed in terms of a SISO and SIMO cases. However, because spatial over-sampling can be used in the equalizer, the number of receive antennas can be two or more.

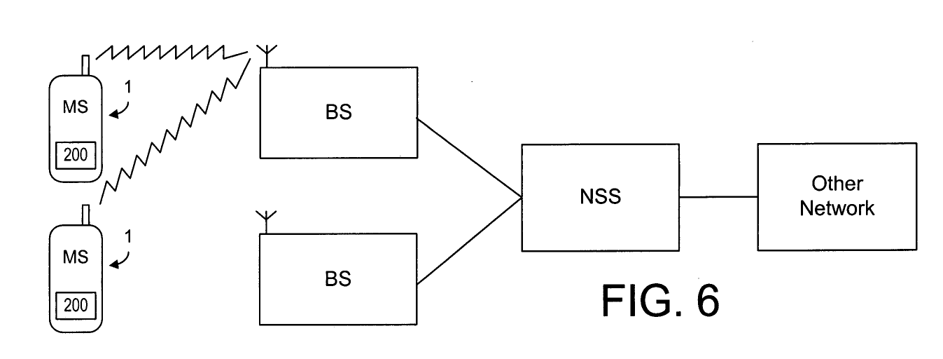

The present invention relates to the channel quality indicator (CQI) derived and reported by an UE (User Equipment) in W-CDMA. The CPICH processing method for estimating the SINR of the CPICH can be extended to other physical channels in W-CDMA. UEs are shown in FIG. 6, a schematic representation of a communications network that can be used for W-CDMA, according to the present invention. As shown in the figure, the network comprises a plurality of Node Bs connected to a UMTS infrastructure, which may also be linked to other networks. The network further comprises a plurality of mobile stations 1 capable of communicating with Node Bs. The mobile station 1 can be a mobile phone or mobile terminal, having a receiver capable of CPICH processing for SINR estimation, according to the present invention. Part of the receiver has one or more receiver filters, CPICH despreading modules and a SINR estimation module as shown in the receive side 200 or 200′, as shown in FIGS. 1 and 2.

Although the invention has been described with respect to a preferred embodiment thereof, it will be understood by those skilled in the art that the foregoing and various other changes, omissions and deviations in the form and detail thereof may be made without departing from the scope of this invention.

1. A method for estimating interference in Common Pilot Channel (CPICH) in a W-CDMA receiver comprising an equalization stage for chip level filtering of received chips, said method comprising
despreading the CPICH channel after said chip level filtering; and
estimating the signal to interference ratio at least partially from despread CPICH symbols.

2. A method according to claim 1, wherein the W-CDMA receiver is for use in a communications system having a transmitter with single antenna transmission.

3. A method according to claim 1, wherein the W-CDMA receiver is for use in a communications system having a transmitter with space-time transmit diversity transmission.

4. A method according to claim 3, wherein a virtual space-time decoding is used on the CPICH channel in order to mimic data channel space-time transformation

5. A method according to claim 3, wherein the received chips are oversampled at chip-level.

6. A receiver for use in a communications system, comprising:
an equalization stage for chip level filtering received chips;
a despreading module for despreading a common pilot channel (CPICH) after said chip level filtering; and
an estimation module for estimating signal-to-interference ratio at least partially from despread CPICH symbols.

7. A receiver according to claim 6, wherein the estimated signal-to-interference ratio is for use by a user equipment in the communications system to report its channel quality indicator (CQI).

8. A receiver according to claim 6, wherein the communications system comprises a transmitter with single antenna transmission.

9. A receiver according to claim 6, wherein the communications system comprises a transmitter with space-time transmit diversity transmission.

10. A receiver according to claim 9, wherein the received chips are over-sampled at chip level.

11. A W-CDMA communications system comprising:
a receiver; and
a transmitter for transmitting a signal stream to the receiver, the signal stream containing a chip stream in a common pilot channel (CPICH), wherein the receiver has at least one antenna to receive one or more chips in the chip stream; the receiver further comprising:
an equalization stage for chip level filtering the received chips;
a despreading module for despreading the common pilot channel after said chip level filtering; and
an estimation module for estimating signal-to-interference ratio at least partially from despread CPICH symbols.

12. A communications system according to claim 11, wherein the estimated signal-to-interference ratio is for use by a user equipment in the communications system to report its channel quality indicator (CQI).

13. A communications system according to claim 11, wherein the transmitter has a single antenna for transmitting the signal stream.

14. A communications system according to claim 11, wherein the transmitter has two or more antennas for transmitting the signal stream in order to achieve space-time transmit diversity.

15. A communications system according to claim 14, wherein the received chips are over-sampled at chip level.

16. A communications system according to claim 14, wherein a virtual space-time decoding in the receiver is used on the CPICH in order to mimic data channel space-time transformation.

17. A communcations device in a communications system, comprising:
an antenna; and
a receiver, operatively connected to the antenna, for receiving communication signals, wherein the communication signals include a transmitted signal indicative of one or more chips in a chip stream in a common pilot channel (CPICH); and wherein the received signals include received chips, the receiver comprising:
an equalization stage for chip level filtering received chips;
a despreading module for despreading a common pilot channel (CPICH) after said chip level filtering; and
an estimation module for estimating signal-to-interference ratio at least partially from despread CPICH symbols.

18. A communications device according to claim 17, wherein the estimated signal-to-interference ratio is used for reporting a channel quality indicator (CQI) to another component in the communication system.

19. A communications device according to claim 17, wherein the communications signals are transmitted with a single antenna at a transmit side.

20. A communications device according to claim 17, wherein the communications signals are transmitted in a space-time transmit diversity transmission fashion.

21. A communications device according to claim 17, comprising a mobile terminal.
